(19) United States
(12) Patent Application Publication
(10) Pub. No.: US 2025/0162628 A1
(43) Pub. Date: May 22, 2025

(54) TRAIN CONTROL METHOD, STORAGE MEDIUM, ON-BOARD CONTROLLER, AND TRAIN

(71) Applicant: BYD COMPANY LIMITED, SHENZHEN (CN)

(72) Inventors: Meizhu CHEN, Shenzhen (CN); Kaikuo ZHUO, Shenzhen (CN); Chujun CHEN, Shenzhen (CN)

(21) Appl. No.: 19/033,339

(22) Filed: Jan. 21, 2025

Related U.S. Application Data
(63) Continuation of application No. PCT/CN2023/085751, filed on Mar. 31, 2023.

(30) Foreign Application Priority Data
Jul. 28, 2022 (CN) 202210901759.1

(51) Int. Cl. B61L 27/20; B61L 27/04

(52) U.S. Cl. CPC B61L 27/20; B61L 27/04

(57) ABSTRACT

A method for controlling a train, includes: detecting whether a communication failure occurs to a target train; in response to detecting that the communication failure occurs to the target train, determining a target failure type of the communication failure; determining a target control strategy of the target train according to the target failure type and a correspondence between a failure type and a control strategy; and controlling traveling of the target train according to the target control strategy.

### CROSS-REFERENCE TO RELATED APPLICATIONS

This application is a continuation application of International Patent Application No. PCT/CN2023/085751, filed on Mar. 31, 2023, which is based on and claims priority to and benefits of Chinese Patent Application No. 202210901759.1, filed on Jul. 28, 2022. The entire content of all of the above-referenced applications is incorporated herein by reference.

### FIELD

The present disclosure relates to the field of rail transit technologies, and more particularly, to a train control method, a storage medium, a vehicle on-board controller, and a train.

### BACKGROUND

Currently, a train autonomous circumambulate system (TACS) obtains line information or front train information based on vehicle-to-vehicle communications and communications between devices in a manner of vehicle-to-ground interlocking and vehicle-to-vehicle coordination, thereby ensuring the train to travel safely and efficiently. However, when a train communication device fails and a train is consequently degraded, a traveling path of the degraded train is usually planned manually and remotely, resulting in low efficiency. In addition, when the train is manually and remotely controlled, an actual traveling situation of the train cannot be learned in real time, and the train is easily affected by an emergency, which is adverse to the safety of the train.

### SUMMARY

The present disclosure provides a train control method, a storage medium, a vehicle on-board controller, and a train.

A first aspect of the present disclosure provides a train control method. The method includes: detecting whether a communication failure occurs to a target train;
in response to detecting that the communication failure occurs to the target train, determining a target failure type of the communication failure;
determining a target control strategy of the target train according to the target failure type and a correspondence between a failure type and a control strategy; and
controlling traveling of the target train according to the target control strategy.

In an embodiment, wherein the determining the target control strategy of the target train according to the target failure type and the correspondence between a failure type and a control strategy includes:
in response to that the target failure type indicates that a communication between the target train and an object controller is interrupted, a communication between the target train and an automatic train supervision system is normal, and a communication between the automatic train supervision system and the object controller is normal, determining that the target control strategy of the target train is a remote control strategy, the remote control strategy indicating that the traveling of the target train is controlled according to a remote control instruction delivered by the automatic train supervision system; or
in response to that the target failure type indicates that a communication between the target train and an object controller is interrupted and a communication between the target train and an automatic train supervision system is interrupted, or the target failure type indicates that the communication between the target train and the object controller is interrupted and the communication between the automatic train supervision system and the object controller is interrupted, determining that the target control strategy of the target train is an autonomous control strategy, the autonomous control strategy indicating that the traveling of the target train is controlled according to a preset traveling plan.

In an embodiment, the controlling traveling of the target train according to the target control strategy includes:
in response to that the target control strategy of the target train is the autonomous control strategy, determining an adjacent train of the target train, applying for a usage permission of the target train for a line resource based on a communication between the target train and the adjacent train and a communication between the adjacent train and the object controller, receiving an application result of the usage permission for the line resource, and controlling the traveling of the target train according to the application result of the usage permission for the line resource; or
applying for a usage permission of the target train for a line resource based on a near field communication between a near field communication module of the target train and a controller of the line resource, receiving an application result of the usage permission for the line resource, and controlling the traveling of the target train according to the application result of the usage permission for the line resource.

In an embodiment, a priority of the usage permission applied based on the near field communication is higher than a priority of the usage permission applied based on the object controller.

In an embodiment, the controlling traveling of the target train according to the target control strategy includes:
in response to that the target control strategy of the target train is the remote control strategy, applying for a usage permission of the target train for a line resource based on the communication between the target train and the automatic train supervision system and the communication between the automatic train supervision system and the object controller; receiving an application result of the usage permission for the line resource; and
controlling the traveling of the target train according to the application result of the usage permission for the line resource.

In an embodiment, the controlling traveling of the target train according to the target control strategy includes:
in response to that the target control strategy of the target train is the remote control strategy, determining an authorized movement distance of the target train according to a minimum distance between a restrained traveling distance in the remote control instruction delivered by the automatic train supervision system and a eligible traveling distance determined by a sensing positioning system of the target train; and
controlling the traveling of the target train according to the authorized movement distance.

In an embodiment, the line resource includes a turnout, a position of the turnout includes a normal position, a reverse position, and a not-in-place position, and a controller of the turnout is configured to: lock the turnout in response to that the turnout is at the normal position or the reverse position, and move the turnout to the not-in-place position in response to that the turnout is not configured to be locked.

The controlling the traveling of the target train according to an application result of the usage permission for the line resource includes: applying for a usage permission for the turnout;
receiving an application result of the usage permission for the turnout that is sent by the controller of the turnout, wherein the application result of the usage permission for the turnout comprises an availability permission for the turnout and an unavailability permission for the turnout, the availability permission indicates that the turnout is at a target position that is applied by the target train and the turnout is locked, and the unavailability permission indicates that the turnout is at a non-target position comprising the not-in-place position; and
in response to that the application result of the usage permission for the turnout is the unavailability permission, controlling the target train to stop before the turnout.

In an embodiment, in response to that the turnout is at a first position and the turnout is not configured to be locked, the controller of the turnout is configured to move the turnout to a second position and control the turnout to be locked, the first position being the normal position or the reverse position, and the second position being a position other than the first position in the normal position or the reverse position; and
in response to that the turnout is not configured to be locked at the second position, move the turnout to the not-in-place position.

A second aspect of the present disclosure further provides a non-transitory computer-readable storage medium having a computer program stored therein. The program, when executed by a processor, implements steps of the method according to embodiments of the first aspect.

A third aspect of the present disclosure further provides a vehicle on-board controller, including:
a memory, having a computer program stored therein; and
a processor, configured to execute the computer program stored in the memory, to implement steps of the method according to embodiments of the first aspect.

A fourth aspect of the present disclosure further provides a train, including the vehicle on-board controller according to embodiments of the third aspect.

Other features and advantages of the present disclosure will be described in detail in the following detailed description.

### BRIEF DESCRIPTION OF THE DRAWINGS

The accompanying drawings are provided to further understand the present disclosure, and they constitute a part of the specification. The accompanying drawings, along with the implementations, are used to explain the present disclosure, and pose no limitation on the present disclosure. In the accompanying drawings:

FIG. 1 is a flowchart of a train control method according to an embodiment of the present disclosure;

FIG. 2 is a schematic diagram of communication interaction of a train autonomous circumambulate system based on vehicle-to-vehicle communication according to an embodiment of the present disclosure;

FIG. 3 is a schematic diagram of a position of a turnout according to an embodiment of the present disclosure; and

FIG. 4 is a schematic diagram a vehicle on-board controller according to an embodiment of the present disclosure.

### DETAILED DESCRIPTION

The following describes the implementations of the present disclosure in detail with reference to the accompanying drawings. It should be understood that the implementations described herein are merely used to describe and explain the present disclosure, but are not to limit the present disclosure.

It should be noted that, all actions of obtaining signals, information, or data in the present disclosure are performed under the premise of complying with corresponding data protection regulations and policies of a country and authorization granted by an owner of a corresponding apparatus.

It should be understood that the steps described in the method implementations of the present disclosure may be performed in a different order and/or in parallel. In addition, the method implementation may include additional steps and/or omit performing shown steps. The scope of the present disclosure is not limited in this aspect. The term “include” and variants thereof used in this specification are open inclusion, that is, “include but not limited to”. The term “based on” is “based at least in part on”. The term “one embodiment” represents “at least one embodiment”. The term “another embodiment” represents “at least one another embodiment”. The term “some embodiments” represents “at least some embodiments”. Related definitions of other terms are provided in the following description.

It should be noted that concepts such as “first” and “second” mentioned in the present disclosure are merely used to distinguish between different apparatuses, modules, or units, but are not used to limit an order or a mutual dependence of functions performed by the apparatuses, modules, or units. It should be noted that, modifications such as “one” and “multiple” mentioned in the present disclosure are illustrative rather than restrictive. A person skilled in the art should understand that, unless otherwise clearly indicated in the context, it should be understood as “one or more”.

Currently, in a train autonomous circumambulate system (TACS) based on vehicle-to-vehicle communication, a train generates a traveling task based on a current position of the train and a traveling plan that is delivered by an automatic train supervision system (ATS), autonomously calculates a requirement for a line resource, takes an opportunity to apply for a usage permission of the line resource from an object controller (OC, also referred to as a line resource management subsystem), locks and uses the line resource after the usage permission is obtained, and actively releases the resource in time after use. However, in the train autonomous circumambulate system based on vehicle-to-vehicle communication, when a train communication device fails and the train is consequently degraded, the train cannot apply for the usage permission of the line resource from the object controller. In this case, a traveling path of the degraded train is usually planned remotely and manually, and the line resource required for the traveling path is manually applied for, resulting in low efficiency. In addition, when the train is manually and remotely controlled, an actual traveling situation of the train cannot be learned in real time, and the train is easily affected by an emergency, which is adverse to the safety of the train. Moreover, a reaction speed of an entire rail transit system is consequently reduced, which affects operation efficiency of the rail transit system.

In view of this, the present disclosure provides a train control method, a storage medium, a vehicle on-board controller, and a train, to resolve the foregoing technical problems.

It should be noted that, the train control method provided in the embodiments of the present disclosure may be applicable to an autonomous driving rail train or a manual driving rail train. In addition, an execution body of the method may be a train or an electronic device installed in a train, for example, a vehicle on-board controller (VOBC). This is not limited in the present disclosure. In the present disclosure, an embodiment is described by using a vehicle on-board controller as the execution body of the method, as an example.

The technical solutions of the present disclosure are described in detail in the following.

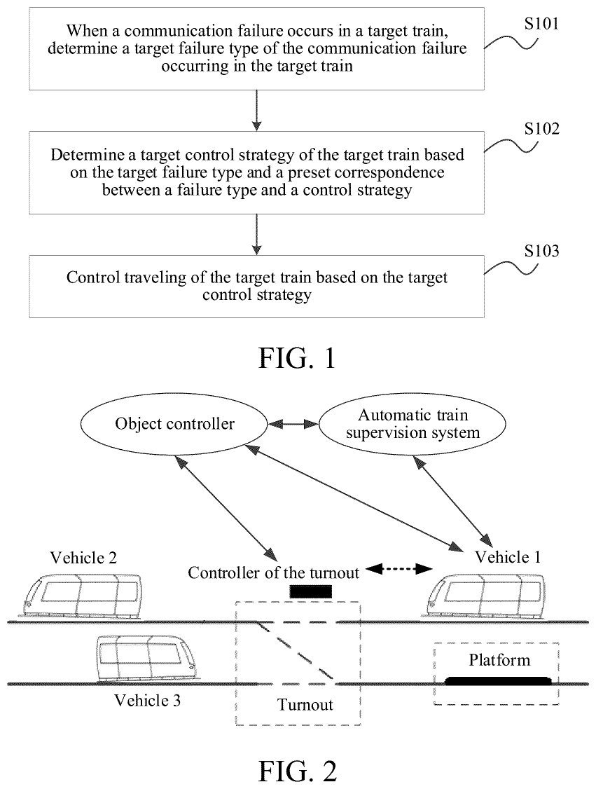

An embodiment of the present disclosure provides a train control method. Referring to FIG. 1, the method includes the following steps.
S101: When a communication failure occurs in a target train, a target failure type of the communication failure occurring in the target train is determined.
S102: A target control strategy of the target train is determined according to the target failure type and a preset correspondence between a failure type and a control strategy.
S103: Traveling of the target train is controlled according to the target control strategy.

According to the foregoing method, when a communication failure occurs in a train, a corresponding control strategy may be determined according to a failure type of the communication failure, and then traveling of the train is controlled according to the control strategy. In comparison with a manner of manually and remotely controlling the traveling of the train, the efficiency of this method is higher, and it is convenient to learn an actual situation of the traveling of the train in real time, to avoid an emergency from affecting the safety of the train, thereby improving the safety of the train.

To enable a person skilled in the art better understand the train control method provided by the present disclosure, the foregoing steps are described in detail below by using examples.

In an implementation, that a target control strategy of the target train is determined according to the target failure type and a preset correspondence between a failure type and a control strategy may include: when the target failure type represents that the communication between the target train and an object controller is interrupted, the communication between the target train and an automatic train supervision system is normal, and the communication between the automatic train supervision system and the object controller is normal, it is determined that the target control strategy of the target train is a remote control strategy, the remote control strategy representing that the traveling of the target train is controlled according to a remote control instruction delivered by the automatic train supervision system. In an embodiment, when the target failure type represents that the communication between the target train and an object controller is interrupted and the communication between the target train and an automatic train supervision system is interrupted, or when the target failure type represents that the communication between the target train and an object controller is interrupted and the communication between an automatic train supervision system and the object controller is interrupted, it is determined that the target control strategy of the target train is an autonomous control strategy, the autonomous control strategy representing that the traveling of the target train is controlled according to a preset traveling plan.

It should be noted that, referring to FIG. 2, when the communication between the train and the object controller and the communication between the train and the automatic train supervision system are both normal, a vehicle on-board controller generates a planning task based on the current position of the train and a traveling plan that is delivered by the automatic train supervision system, autonomously calculates a requirement for a line resource, and takes an opportunity to apply for a usage permission of the line resource from the object controller. The object controller determines an application result of the usage permission, a controller of the line resource controls a state of the line resource according to the application result, and the vehicle on-board controller controls the traveling of the train according to the application result. The line resource includes a turnout, a track section, a platform, a turn-back track, and the like.

For example, when the communication between the target train and the object controller is interrupted, the communication between the target train and the automatic train supervision system is normal, and the communication between the automatic train supervision system and the object controller is normal, because the train cannot apply for the usage permission of the line resource from the object controller, but the communication between the train and the automatic train supervision system is normal, the automatic train supervision system may apply for the usage permission of the line resource from the object controller. Therefore, the traveling of the target train may be controlled according to the remote control instruction delivered by the automatic train supervision system. If the communication between the train and the object controller and the communication between the train and the automatic train supervision system are both interrupted, or the communication between the train and the object controller and the communication between the automatic train supervision system and the object controller are both interrupted, the traveling of the target train is controlled according to the preset traveling plan.

It should be noted that, in a case of normal communication, the traveling plan of the train is delivered by the automatic train supervision system to a controller or storage device related to the train, and an initial traveling plan is usually delivered before the train travels. In addition, during the traveling of the train, the automatic train supervision system adjusts the traveling plan in real time according to a line operating status, a train traveling status, and the like, and redelivers the traveling plan. Therefore, the preset traveling plan is the latest version of a traveling plan received before the communication failure occurs in the train. The traveling plan includes information such as a traveling line and traveling time.

In an implementation, that traveling of the target train is controlled according to the target control strategy may include: when the target control strategy of the target train is the remote control strategy, a usage permission of the target train for a line resource is applied for based on the communication between the target train and the automatic train supervision system and the communication between the automatic train supervision system and the object controller, and then the traveling of the target train is controlled according to an application result of the usage permission.

For example, when the target control strategy of the target train is the remote control strategy, referring to FIG. 2, the train (for example, a vehicle 1) communicates with the automatic train supervision system, and the automatic train supervision system communicates with the object controller. In an embodiment, the target train communicates with the automatic train supervision system, the vehicle on-board controller obtains the traveling plan delivered by the automatic train supervision system, generates the traveling task according to the current position of the train, autonomously calculates the requirement for the line resource, and takes an opportunity to apply for the usage permission of the line resource from the automatic train supervision system. After receiving an application request of the usage permission, the automatic train supervision system communicates with the object controller. The object controller may determine the application result of the usage permission according to a use situation of the corresponding line resource, and feed back the application result to the train through the automatic train supervision system. Then, the vehicle on-board controller controls the traveling of the train according to the application result. For example, when the line resource is the track section, if the application result represents that the track section is available, the train is controlled to pass through the track section, otherwise the train is controlled to stop before the track section.

In addition, the automatic train supervision system may adjust the traveling plan of the train according to the application result. For example, when the application result represents that the track section is unavailable, a new traveling path is planned, and a new traveling plan is redelivered to the vehicle on-board controller, so that the vehicle on-board controller generates a traveling task again based on the new traveling plan.

For example, after receiving the application request of the usage permission, the automatic train supervision system may automatically communicate with the object controller, and request the object controller to perform a corresponding operation according to the application request. In an embodiment, a train dispatcher may manually operate on an operation interface. This is not limited in the present disclosure. An example in which the line resource is a single turnout is used. The operation interface prompts that a normal position and a reverse position can be selected. The train dispatcher selects, according to the application request, a position at which the turnout is to be locked (the normal position or the reverse position). After receiving a corresponding single locking instruction, the object controller moves the turnout to a corresponding position and locks the turnout. If the turnout is already at an intended/targeted position delivered by using an interface instruction of the automatic train supervision system, the object controller directly sets the turnout to a locked status, to ensure normal traveling of the train.

In an implementation, the train dispatcher may operate on the operation interface manually according to the traveling plan delivered to the train, to request, from the object controller, the usage permission of the line resource required for the traveling of the train, and feed back, after obtaining the application result of the corresponding usage permission, the application result to the train, so that the vehicle on-board controller controls the traveling of the target train according to the application result. This is not limited in the present disclosure.

In an implementation, that traveling of the target train is controlled according to the target control strategy may include: when the target control strategy of the target train is the remote control strategy, an authorized movement distance of the target train is determined according to a minimum distance between a limited/restrained traveling distance in the remote control instruction delivered by the automatic train supervision system and a to be traveled distance or an eligible traveling distance determined by a sensing positioning system of the target train, and the traveling of the target train is controlled according to the authorized movement distance.

For example, the train dispatcher may input the limited traveling distance of the target train on the operation interface of the automatic train supervision system according to a traveling status of the entire rail transit system, and then generate the remote control instruction and deliver the remote control instruction to the target train. The train dispatcher may adjust the limited traveling distance in real time according to the traveling status of the train or the operating status of the line resource. In addition, the sensing positioning system of the train determines the to be traveled distance of the train based on a line condition such as an identified turnout or obstacle and under a requirement of a security protection of the train. Then, the minimum distance between the limited traveling distance and the to be traveled distance is used as the authorized movement distance of the target train, and finally, the vehicle on-board controller controls the traveling of the target train according to the authorized movement distance, to ensure the safety of the train.

In an implementation, that traveling of the target train is controlled according to the target control strategy may include: when the target control strategy of the target train is the autonomous control strategy, an adjacent train of the target train is determined or detected, a usage permission of the target train for a line resource is applied for based on the communication between the target train and the adjacent train and the communication between the adjacent train and the object controller, or the communication between the adjacent train and the object controller through the automatic train supervision system, and the traveling of the target train is controlled according to an application result of the usage permission. In an embodiment, a usage permission of the target train for a line resource is applied for based on near field communication between a near field communication module of the target train and a controller of the line resource, and the traveling of the target train is controlled according to an application result of the usage permission.

For example, referring to FIG. 2, in which the vehicle 1 is the target train is used. When the target control strategy of the target train is the autonomous control strategy, a vehicle on-board controller of the vehicle 1 controls traveling of the vehicle 1 according to a preset traveling plan. If the vehicle 1 needs to apply for a corresponding line resource (for example, a turnout) during traveling, an adjacent train in a vehicle-to-vehicle communication range may be searched for. For example, if a vehicle 2 is the adjacent train, the vehicle 1 establishes vehicle-to-vehicle communication with the vehicle 2, and the vehicle 1 sends an application request for applying for a usage permission of the line resource to the vehicle 2. The vehicle 2 forwards the application request according to a communication status of the vehicle 2 after receiving the application request. For example, when communication between the vehicle 2 and the object controller is normal, the vehicle 2 directly forwards the application request to the object controller. If communication between the vehicle 2 and the object controller is abnormal, reference may be made to the foregoing embodiment in which a control strategy of the vehicle 1 is the remote control strategy. Details are not described herein again in the present disclosure. Finally, the vehicle on-board controller of the vehicle 1 controls the traveling of the vehicle 1 according to a fed back application result of the usage permission.

For example, a near field communication module may be configured in the vehicle on-board controller, and a near field communication module may also be arranged/configured in the controller of the line resource. The near field communication module may be a module that supports near field communication, such as an NFC module or a Bluetooth module. This is not limited in the present disclosure. Referring to FIG. 2, an example in which the vehicle 1 is the target train is used. When the target control strategy of the target train is the autonomous control strategy, the vehicle 1 may perform near field communication with the controller of the line resource (for example, a controller of a turnout), and directly apply for the usage permission of the line resource from the controller of the line resource. The vehicle on-board controller of the vehicle 1 controls the traveling of the vehicle 1 according to a fed back application result of the usage permission.

It should be noted that a near field communication manner or an adjacent-train communication manner may be selected according to a requirement. In an embodiment, a near field communication manner may be selected when an adjacent train cannot be found or vehicle-vehicle communication is abnormal, or an adjacent-train communication manner is used when an abnormality occurs in a near field communication manner. This is not limited in the present disclosure. In addition, the object controller may be configured with a near field communication module. When a communication failure occurs between the object controller and the train, the near field communication manner is enabled for communication. This is not limited in the present disclosure.

In an implementation, a priority of the usage permission applied based on the near field communication is higher than a priority of the usage permission applied according to the object controller.

For example, the authorized movement distance of the train does not exceed that of a train traveling ahead under the limitation of the to be traveled distance determined by the sensing positioning system. Therefore, the train and the train traveling ahead do not simultaneously apply for a same line resource. In addition, the object controller allocates usage permissions of line resources of different trains in sequence according to a priority order of applying for the line resources by the different trains. When the communication between the object controller and the target train is interrupted, the object controller cannot learn the application request of the target train for the line resource, and a communication range of near field communication is much less than a communication range of network communication used by the object controller. Therefore, the priority of the usage permission applied based on the near field communication is set to be higher than the priority of the usage permission applied according to the object controller, to avoid a case that a following traveling train occupies the usage permission of the line resource in advance, and the target train consequently cannot use the line resource, or avoid a case that the object controller moves the turnout when the target train is using the turnout.

In an implementation, the line resource includes a turnout, and a position of the turnout includes a normal position, a reverse position, and a preset not-in-place position. A controller of the turnout can control, in response to the position of the turnout being the normal position or the reverse position, the turnout to be locked, and move the turnout to the preset not-in-place position when the turnout cannot be locked. That the traveling of the target train is controlled according to an application result of the usage permission includes: an application result that is of a usage permission for the turnout and that is sent by the controller of the turnout is received, where the application result of the usage permission includes an availability permission and an unavailability permission, the availability permission represents that the position of the turnout is a target position applied by the target train and the turnout is locked, and the unavailability permission represents that the position of the turnout is a non-target position (e.g., a position other than the target position) including the preset not-in-place position. If the application result of the usage permission is the unavailability permission, the target train is controlled to stop before the turnout.

For example, the controller of the turnout is configured to move, when the position of the turnout is a first position and the turnout cannot be locked, the turnout to a second position and control the turnout to be locked, the first position being the normal position or the reverse position, and the second position being a position other than the first position in the normal position and the reverse position; and if the turnout cannot be locked at the second position, move the turnout to the preset not-in-place position.

It should be noted that, in the related art, the turnout is usually in an unlocked status. The turnout is controlled to be locked when the train applies to use the turnout, and the turnout is controlled to be unlocked after use is completed. In the embodiments of the present disclosure, after the object controller is powered on or restarted, an operator performs a corresponding unlocking operation, for example, enters a password or a verification code to unlock a control region of the object controller, so that the object controller obtains control rights of all line resources in the control region. In addition, after the unlocking operation is performed, all track sections in the control region are set to an unlocked status, but the turnout in the control region is controlled to be locked. In addition, when the object controller operates the turnout according to an operation instruction delivered by the automatic train supervision system or an application instruction sent by the vehicle on-board controller, if a current position of the turnout is consistent with a position in the instruction, the object controller determines that the turnout does not need to be moved and controls the turnout to be locked, so that the turnout is locked if the turnout is in position. If the current position of the turnout is not consistent with the position in the instruction, the object controller controls the turnout to be locked after moving the turnout to the position in the instruction, so that the turnout is locked if the turnout is moved.

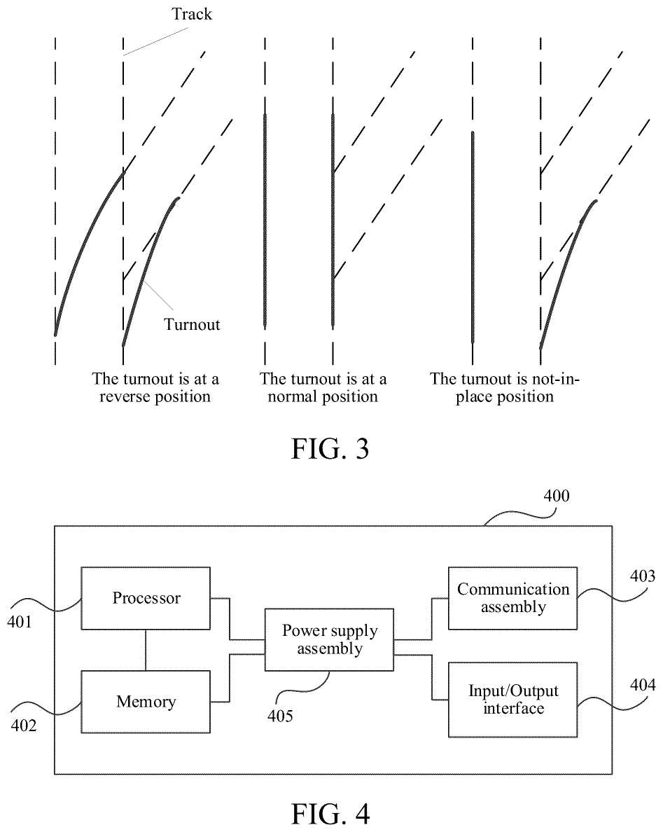

In an embodiment, if the object controller cannot lock the turnout due to some failure reasons after moving the turnout in position, for example, a failure occurs in a locking relay of the turnout, after it is further determined that the turnout cannot be locked, the object controller may move the turnout to the preset not-in-place position. For example, when the object controller determines, through collection, that the turnout is in an unlocked status or the object controller cannot receive information about the locked status of the turnout, the object controller autonomously moves the turnout back to a position before moving, where either the normal position or the reverse position is supported (referring to FIG. 3). If the turnout still cannot be locked when the object controller moves the turnout to the position that is before a moving instruction of this time is executed, the object controller controls the turnout to move away from the normal position or the reverse position, that is, moves the turnout to the preset not-in-place position (referring to FIG. 3). In an embodiment, when the object controller controls the turnout to be locked when the turnout is in position, if the turnout cannot be locked, the object controller moves the turnout away from the current position and then lock the turnout. If the turnout still cannot be locked, the object controller moves the turnout to the preset not-in-place position. In an implementation, the object controller may perform an operation of moving and locking the turnout for multiple times. If the turnout cannot be locked, the object controller moves the turnout to the preset not-in-place position, or may perform an operation of locking the turnout again after preset duration. If the turnout still cannot be locked, the object controller moves the turnout to the preset not-in-place position, or the like. This is not limited in the present disclosure. In addition, in a case of multiple turnouts, the turnouts may be moved in sequence to multiple positions and locked to determine whether the turnouts need to be moved to the preset not-in-place position.

It should be noted that an execution body of controlling the turnout may be the controller of the turnout, and the object controller delivers a corresponding instruction to the controller of the turnout. For details, reference may be made to the related art, and details are not described herein again in the present disclosure. When the target train applies for the usage permission of the turnout from the controller of the turnout through near field communication, the controller of the turnout directly controls the turnout to perform an operation such as moving or locking. In addition, regardless of whether the usage permission of the turnout is applied for by using the object controller or the usage permission of the turnout is directly applied for from the controller of the turnout, the application request needs to include a corresponding turnout position (e.g., the target position), so that the object controller or the controller of the turnout allocates the usage permission of the turnout according to the turnout position in the application request.

For example, because the turnout is normally in the locked status, when the target train requests the usage permission of the turnout from the object controller through the automatic train supervision system, and when the operator requests to control the turnout through the operation interface, the operator needs to first deliver an unlocking instruction for the turnout and then deliver a control instruction for the turnout, to further confirm that the turnout can respond to an instruction of the automatic train supervision system. In addition, a case that when a train with a communication failure uses the turnout, the controller of the turnout moves the turnout in response to a use request of another train with normal communication can be avoided, thereby ensuring safety when the train passes through the turnout.

For example, when the target train applies for the usage permission of the turnout from the controller of the turnout through near field communication, the controller of the turnout moves the turnout according to the target position applied by the target train. If the turnout can be moved to the target position and locked, a permission result that the turnout can be used is fed back to the target train. If the turnout is at the non-target position, for example, the turnout is occupied and cannot be moved to the target position, the turnout is moved to the target position but cannot be locked, and is moved to another position, or the turnout is moved to another position but still cannot be locked, and is moved to the preset not-in-place position, a permission result that the turnout cannot be used is fed back to the target train. In an embodiment when the target train can use the turnout, the target train is controlled to pass the turnout, or when the target train cannot use the turnout, the target train is controlled to stop before the turnout.

It should be noted that, during the traveling of the train, a to-be-traveled line ahead, including the position of the turnout, may be detected by using the sensing positioning system. Devices in the sensing positioning system of the train include a lidar, a millimeter wave radar, a monocular camera, an inertial measurement unit, and a Beidou system. A positioning algorithm and an obstacle algorithm are fused with reference to AI. After a series of training such as data collection, data cleaning, data annotation, model training and generation, and model use is performed, the sensing positioning system may identify, according to different point cloud data information, whether the position of the turnout is at the normal position, the reverse position, or the not-in-place position (as shown in FIG. 3). Therefore, during the traveling of the train, whether the position of the turnout satisfies a traveling requirement is further determined through the sensing positioning system. For example, when the sensing positioning system detects that the current position of the turnout matches a track path line required for traveling and is continuous, the sensing positioning system reports information to the vehicle on-board controller, and the vehicle on-board controller may control the train to travel through the turnout. In an embodiment, when the sensing positioning system detects that the current position of the turnout does not match a track path line required for traveling, the sensing positioning system reports information to the vehicle on-board controller, and the vehicle on-board controller may control the train to stop before the turnout.

In addition, when the communication between the train and the object controller is normal, the position of the turnout may be detected by the sensing positioning system, or the position of the turnout fed back by the object controller may be received after the use request for the turnout is sent to the object controller. In addition, when it is determined that the position of the turnout is at the preset not-in-place position, the train may autonomously switch the traveling path according to the traveling plan, or apply for a new traveling path to the automatic train supervision system. This is not limited in the present disclosure.

According to the foregoing method, when a communication failure occurs in a train, a corresponding control strategy may be determined according to a failure type of the communication failure, and then traveling of the train is controlled according to the control strategy. In comparison with a manner of manually and remotely controlling the traveling of the train, efficiency is higher. In addition, an actual situation of the traveling of the train is detected in real time by using the sensing positioning system of the train, to prevent an emergency from affecting the safety of the train, thereby ensuring the safety of the train. In this way, autonomous traveling of the train is implemented when the communication failure occurs in the train, so that operation efficiency of the rail transit system is improved.

Based on the same inventive concept, an embodiment of the present disclosure further provides a non-transitory computer-readable storage medium, having a computer program stored therein. The program, when executed by a processor, implements steps of the foregoing train control method.

Based on the same inventive concept, an embodiment of the present disclosure further provides a vehicle on-board controller, including:
a memory, having a computer program stored therein; and
a processor, configured to execute the computer program in the memory, to implement steps of the foregoing train control method.

Based on the same inventive concept, an embodiment of the present disclosure further provides a train, including the foregoing vehicle on-board controller.

FIG. 4 is a block diagram of a vehicle on-board controller 400 according to an exemplary embodiment. Referring to FIG. 4, the vehicle on-board controller 400 includes one or more processors 401, and a memory 402 configured to store a computer program executable by the processor 401. The computer program stored in the memory 402 may include one or more modules, and each module corresponds to a group of instructions. In addition, the processor 401 may be configured to execute the computer program to perform the foregoing train control method.

In addition, the vehicle on-board controller 400 may further include a power supply assembly 405 and a communication assembly 403. The power supply assembly 405 may be configured to perform power supply management of the vehicle on-board controller 400, and the communication assembly 403 may be configured to implement communication, for example, wired or wireless communication, of the vehicle on-board controller 400. In addition, the vehicle on-board controller 400 may further include an input/output (I/O) interface 404. The vehicle on-board controller 400 may operate an operating system, for example, Windows Server™, Mac OS XTM, Unix™, Linux™, and the like stored in the memory 402.

In an embodiment, a computer-readable storage medium including program instructions is further provided. The program instructions, when executed by a processor, implement steps of the foregoing train control method. For example, the non-transitory computer-readable storage medium may be the foregoing memory 402 including program instructions, and the foregoing program instructions may be performed by the processor 401 of the vehicle on-board controller 400 to complete the foregoing train control method.

In an embodiment, a computer program product is further provided. The computer program product includes a computer program executable by a programmable apparatus. The computer program includes code portions for performing the foregoing train control method when executed by the programmable apparatus.

The exemplary embodiments of the present disclosure are described in detail above with reference to the accompanying drawings, but the present disclosure is not limited to the details in the above embodiments. Various simple variations may be made to the technical solutions of the present disclosure within the scope of the technical idea of the present disclosure, and such simple variations shall all fall within the protection scope of the present disclosure.

In addition, it should be noted that, the technical features described in the foregoing implementations may be combined in any suitable manner without contradiction. To avoid unnecessary repetition, various possible combinations are not further described in the present disclosure.

In addition, the various embodiments of the present disclosure may be combined without departing from the idea of the present disclosure, and such combinations shall also fall within the scope of the present disclosure.

What is claimed is:

1. A method for controlling a train, comprising:
detecting whether a communication failure occurs to a target train;
in response to detecting that the communication failure occurs to the target train, determining a target failure type of the communication failure;
determining a target control strategy of the target train according to the target failure type and a correspondence between a failure type and a control strategy; and
controlling traveling of the target train according to the target control strategy.

2. The method according to claim 1, wherein the determining the target control strategy of the target train according to the target failure type and the correspondence between a failure type and a control strategy comprises:
in response to that the target failure type indicates that a communication between the target train and an object controller is interrupted, a communication between the target train and an automatic train supervision system is normal, and a communication between the automatic train supervision system and the object controller is normal, determining that the target control strategy of the target train is a remote control strategy, the remote control strategy indicating that the traveling of the target train is controlled according to a remote control instruction delivered by the automatic train supervision system; or
in response to that the target failure type indicates that a communication between the target train and an object controller is interrupted and a communication between the target train and an automatic train supervision system is interrupted, or the target failure type indicates that the communication between the target train and the object controller is interrupted and the communication between the automatic train supervision system and the object controller is interrupted, determining that the target control strategy of the target train is an autonomous control strategy, the autonomous control strategy indicating that the traveling of the target train is controlled according to a preset traveling plan.

3. The method according to claim 2, wherein the controlling traveling of the target train according to the target control strategy comprises:
in response to that the target control strategy of the target train is the autonomous control strategy, determining an adjacent train of the target train, applying for a usage permission of the target train for a line resource based on a communication between the target train and the adjacent train and a communication between the adjacent train and the object controller, receiving an application result of the usage permission for the line resource, and controlling the traveling of the target train according to the application result of the usage permission for the line resource; or
applying for a usage permission of the target train for a line resource based on a near field communication between a near field communication module of the target train and a controller of the line resource, receiving an application result of the usage permission for the line resource, and controlling the traveling of the target train according to the application result of the usage permission for the line resource.

4. The method according to claim 3, wherein a priority of the usage permission applied based on the near field communication is higher than a priority of the usage permission applied based on the object controller.

5. The method according to claim 2, wherein the controlling traveling of the target train according to the target control strategy comprises:
in response to that the target control strategy of the target train is the remote control strategy, applying for a usage permission of the target train for a line resource based on the communication between the target train and the automatic train supervision system and the communication between the automatic train supervision system and the object controller;
receiving an application result of the usage permission for the line resource; and
controlling the traveling of the target train according to the application result of the usage permission for the line resource.

6. The method according to claim 2, wherein the controlling traveling of the target train according to the target control strategy comprises:
in response to that the target control strategy of the target train is the remote control strategy, determining an authorized movement distance of the target train according to a minimum distance between a restrained traveling distance in the remote control instruction delivered by the automatic train supervision system and an eligible traveling distance determined by a sensing positioning system of the target train; and
controlling the traveling of the target train according to the authorized movement distance.

7. The method according to claim 3, wherein:
the line resource comprises a turnout, a position of the turnout comprises a normal position, a reverse position, and a not-in-place position, and a controller of the turnout is configured to: lock the turnout in response to that the turnout is at the normal position or the reverse position, and move the turnout to the not-in-place position in response to that the turnout is not configured to be locked; and
the controlling the traveling of the target train according to an application result of the usage permission for the line resource comprises:
applying for a usage permission for the turnout;
receiving an application result of the usage permission for the turnout that is sent by the controller of the turnout, wherein the application result of the usage permission for the turnout comprises an availability permission for the turnout and an unavailability permission for the turnout, the availability permission indicates that the turnout is at a target position that is applied by the target train and the turnout is locked, and the unavailability permission indicates that the turnout is at a non-target position comprising the not-in-place position; and
in response to that the application result of the usage permission for the turnout is the unavailability permission, controlling the target train to stop before the turnout.

8. The method according to claim 7, wherein:
in response to that the turnout is at a first position and the turnout is not configured to be locked, the controller of the turnout is configured to move the turnout to a second position and control the turnout to be locked, the first position being the normal position or the reverse position, and the second position being a position other than the first position in the normal position or the reverse position; and
in response to that the turnout is not configured to be locked at the second position, move the turnout to the not-in-place position.

9. A non-transitory computer-readable storage medium, storing a computer program, wherein the computer program, when executed by a processor, causes the processor to perform operations comprising:
detecting whether a communication failure occurs to a target train;
in response to detecting that the communication failure occurs to the target train, determining a target failure type of the communication failure;
determining a target control strategy of the target train according to the target failure type and a correspondence between a failure type and a control strategy; and
controlling traveling of the target train according to the target control strategy.

10. A vehicle on-board controller, comprising:
a memory storing a computer program; and
a processor (401), configured to execute the computer program in the memory (402), to perform operations comprising:
detecting whether a communication failure occurs to a target train;
in response to detecting that the communication failure occurs to the target train, determining a target failure type of the communication failure;
determining a target control strategy of the target train according to the target failure type and a correspondence between a failure type and a control strategy; and
controlling traveling of the target train according to the target control strategy.

11. The vehicle on-board controller according to claim 10, wherein the determining the target control strategy of the target train according to the target failure type and the correspondence between a failure type and a control strategy comprises:
in response to that the target failure type indicates that a communication between the target train and an object controller is interrupted, a communication between the target train and an automatic train supervision system is normal, and a communication between the automatic train supervision system and the object controller is normal, determining that the target control strategy of the target train is a remote control strategy, the remote control strategy indicating that the traveling of the target train is controlled according to a remote control instruction delivered by the automatic train supervision system; or
in response to that the target failure type indicates that a communication between the target train and an object controller is interrupted and a communication between the target train and an automatic train supervision system is interrupted, or the target failure type indicates that the communication between the target train and an object controller is interrupted and the communication between the automatic train supervision system and the object controller is interrupted, determining that the target control strategy of the target train is an autonomous control strategy, the autonomous control strategy indicating that the traveling of the target train is controlled according to a preset traveling plan.

12. The vehicle on-board controller according to claim 11, wherein the controlling traveling of the target train according to the target control strategy comprises:
in response to that the target control strategy of the target train is the autonomous control strategy, determining an adjacent train of the target train, applying for a usage permission of the target train for a line resource based on a communication between the target train and the adjacent train and a communication between the adjacent train and the object controller, receiving an application result of the usage permission for the line resource, and controlling the traveling of the target train according to the application result of the usage permission for the line resource; or
applying for a usage permission of the target train for a line resource based on a near field communication between a near field communication module of the target train and a controller of the line resource, receiving an application result of the usage permission for the line resource, and controlling the traveling of the target train according to the application result of the usage permission for the line resource.

13. The vehicle on-board controller according to claim 12, wherein a priority of the usage permission applied based on the near field communication is higher than a priority of the usage permission applied based on the object controller.

14. The vehicle on-board controller according to 11, wherein the controlling traveling of the target train according to the target control strategy comprises:
in response to that the target control strategy of the target train is the remote control strategy, applying for a usage permission of the target train for a line resource based on the communication between the target train and the automatic train supervision system and the communication between the automatic train supervision system and the object controller;
receiving an application result of the usage permission for the line resource; and
controlling the traveling of the target train according to the application result of the usage permission for the line resource.

15. The vehicle on-board controller according to 11, wherein the controlling traveling of the target train according to the target control strategy comprises:
in response to that the target control strategy of the target train is the remote control strategy, determining an authorized movement distance of the target train according to a minimum distance between a restrained traveling distance in the remote control instruction delivered by the automatic train supervision system and an eligible traveling distance determined by a sensing positioning system of the target train; and
controlling the traveling of the target train according to the authorized movement distance.

16. The vehicle on-board controller according to 12, wherein:
the line resource comprises a turnout, a position of the turnout comprises a normal position, a reverse position, and a not-in-place position, and a controller of the turnout is configured to: lock the turnout in response to that the turnout is at the normal position or the reverse position, and move the turnout to the not-in-place position in response to that the turnout is not configured to be locked; and
the controlling the traveling of the target train according to an application result of the usage permission for the line resource comprises:
applying for a usage permission for the turnout;
receiving an application result of the usage permission for the turnout that is sent by the controller of the turnout, wherein the application result of the usage permission for the turnout comprises an availability permission for the turnout and an unavailability permission for the turnout, the availability permission indicates that the turnout is at a target position that is applied by the target train and the turnout is locked, and the unavailability permission indicates that the turnout is at a non-target position comprising the not-in-place position; and
in response to that the application result of the usage permission for the turnout is the unavailability permission, controlling the target train to stop before the turnout.

17. The vehicle on-board controller according to 16, wherein:
in response to that the turnout is at a first position and the turnout is not configured to be locked, the controller of the turnout is configured to move the turnout to a second position and control the turnout to be locked, the first position being the normal position or the reverse position, and the second position being a position other than the first position in the normal position or the reverse position; and
in response to that the turnout is not configured to be locked at the second position, move the turnout to the not-in-place position.

18. A train, comprising the vehicle on-board controller according to claim 10.
